(19) United States
(12) Patent Application Publication
(10) Pub. No.: US 2003/0013027 A1
(43) Pub. Date: Jan. 16, 2003

(54) Ceramic decal

(75) Inventor: William Peter Wallace, Christchurch (NZ)

Correspondence Address: YOUNG & THOMPSON, 745 SOUTH 23RD STREET 2ND FLOOR, ARLINGTON, VA, 22202

(73) Assignee: WALLACE ARCHIVING LIMITED, Christchurch (NZ)

(21) Appl. No.: 10/193,299

(22) Filed: Jul. 12, 2002

(30) Foreign Application Priority Data
Jul. 13, 2001 (NZ) 512952

(51) Int. Cl. G03G 13/06; G03G 13/00

(52) U.S. Cl. 430/31; 430/9

(57) ABSTRACT

A ceramic decal which can be transferred to a ceramic substrate. The decal comprises a desired digital graphic image. The decal is prepared in a one-step process without the need for either a film separation step or a screen-printing or similar printing step. The digital graphic image is printed, by using ceramic toner in a color laser printer, onto suitable decal paper. The decal paper is then over coated by screen-printing or hot laminating.

### FIELD OF INVENTION

The invention relates to a process for preparing ceramic decals having high resolution images and to their application to ceramic substrates and the like; and to the ceramic substrates to which they are applied.

### BACKGROUND

Ceramic substrates have long been used as a medium on to which decoration and colors have been applied. Ceramics are also well known to make decorative wall and floor tiles.

Conventionally, ceramic wall and floor tiles have been decorated using direct screen printing methods whereby the screened material is applied directly to the unfired glazed substrate.

In these previously known processes an image may be produced by placing a stencil over the glazed substrate and subsequently adding dyes, inks or colored glazes, as appropriate. However, the resolution provided by such a process is generally poor in quality and has a discontinuous form.

Furthermore, full coverage of the substrate is extremely difficult, if not impossible, to achieve.

It should be further understood that the application of decals to surfaces such as bronze and aluminium have met with considerably more success than is presently found with their application to ceramics. Metal surfaces such as bronze and aluminium, however, are easily scratched and damaged. Any decal applied to these surfaces is generally of a transient nature with a short lifespan. Such surfaces are particularly adversely affected by climatic and environmental factors, such as extremes in temperature.

There are a number of documented techniques for applying decals to porous substrates including ceramics, stone, and textiles such as canvas.

For example, it is known to provide a five-step method for applying an image to a porous substrate. The steps include the application of a digitised four color printer derived high-resolution image on to a duplex or decal paper pre-coated with an adhesive layer. The digitalised image is then placed on the substrate and pressure is applied to the non-image part of the coated paper. This results in at least some of the image being absorbed on to the substrate.

All of the foregoing requires the translation, even in the case of digitally prepared images, of the image using a film medium. Generally the film is prepared on an image setting device and later exposed onto a light sensitive emulsion coating on a silk screen or similar. This has to be done for each of the four colors which are then separately screen printed onto decal paper.

The previously known processes are expensive, labour intensive and require constant monitoring and checking. There is a need therefore, for an improved process for the application of decals to ceramic surfaces and the like.

The present invention eliminates the need for the film separations, one for each desired color. Consequently, the necessity to print the image by screen-printing is also eliminated.

The present invention therefore provides a unique, cost-effective method for preparing large and small batch-lots and one-offs of personalised decals. The method also provides for full coverage, if that is desired, of the substrate to which it is applied.

It is envisaged that the unique method according to the present invention would be used for preparing memorial plaques and replicas, headstones, tombstones and the like, but would also have use in the commercial area identifying or adorning corporate offices and workplaces for example. It is also envisaged that they would offer strong advertising advantage as almost any scene, identity or situation, or stylised logo could be easily prepared and transferred to any appropriate ceramic surface.

### SUMMARY OF INVENTION

The object of the invention is to provide a process for preparing decals suitable for ceramic surfaces and to the ceramic substrates including those decals; or at least to provide the public with a useful choice.

A further object of the invention is to provide an effective means for preparing a decal for decorating or inscribing a ceramic plaque, headstone, tombstone, memorial, monument, or the like wherein the inscription or decoration is reproduced from a digital image.

Other and more particular objects and advantages of the invention will become apparent from the ensuing description.

According to a first aspect of the invention there is provided a decal for a ceramic substrate on to which the decal can be transferred, the decal comprising a desired digital graphic image and wherein the decal is prepared in a one-step process without the need for either a film separation step or a screen-printing or similar printing step.

According to a further broad aspect of the invention there is provided a process for producing a decal for a ceramic substrate the process including the steps of:—

(a) digitally preparing an image;

(b) converting the image prepared in step (a) to a format suitable for a color laser printer;

(c) converting a color laser printer to a ceramic decal printer;

(d) using the converted laser color printer to print the image prepared in step (c) as a decal; and

(e) cover coating the decal.

According to a further broad aspect of the invention there is provided a ceramic substrate produced by a process including the steps of:

(i) selecting a desired substrate of ceramic form,

(ii) digitally preparing an image conveying an inscription or decoration of a desired content and to a desired size,

(iii) converting the image prepared in step (ii) to a format suitable for a color laser printer,

(iv) converting a color laser printer to a ceramic decal printer,

(v) printing the image prepared in step (iii) as a decal and

(vi) cover coating the decal and applying the cover coated decal to the substrate by conventional techniques.

Preferably the image is prepared in a format suitable for a color laser printer via a Raster Image Processor or the like. The image can then be sent through a color laser copier.

Preferably, the color laser printer is adopted or converted to a ceramic decal printer by a process which comprises replacing the color laser printer toner with specially prepared ceramic toner.

Preferably, the color laser printer is further adapted to accommodate decal paper. Thus a color laser copy can be achieved by passing sheets of suitable decal paper through the color laser copier.

Preferably, the decal paper carrying this image is cover coated. The cover coat can comprise a hot laminate.

Alternatively a cover coat can be screen-printed onto the decal.

Preferably, the cover coat comprises a mixture of laminate, flux (ground glass) and screen-printing oil. This mixture enables the cover coat to be applied, in association with the mesh size of the screen, at a thickness that can be varied depending on the outcome desired.

Preferably, the substrate is in the form of a ceramic plaque.

Preferably, the plaque can have bevelled edges and even a slightly convex surface. If used in a horizontal application such as a grave marking, for example, the plaque will self wash due to rain.

Preferably, the area on the substrate selected to accommodate the image is glazed with durability to provide abrasion resistance and yet absorb stone shock from mowers and the like.

### BRIEF DESCRIPTION OF THE DRAWINGS

Some preferred aspects of the invention are hereafter described with reference to the accompanying drawings. It will be appreciated that other variations of and modifications to the invention can take place without departing from the scope of the invention.

FIG. 1 represents a ceramic decal in vertical (portrait) attitude. The image has a ceramic margin.

FIG. 2 represents a ceramic decal in horizontal (landscape) attitude. The image fully covers the ceramic substrate.

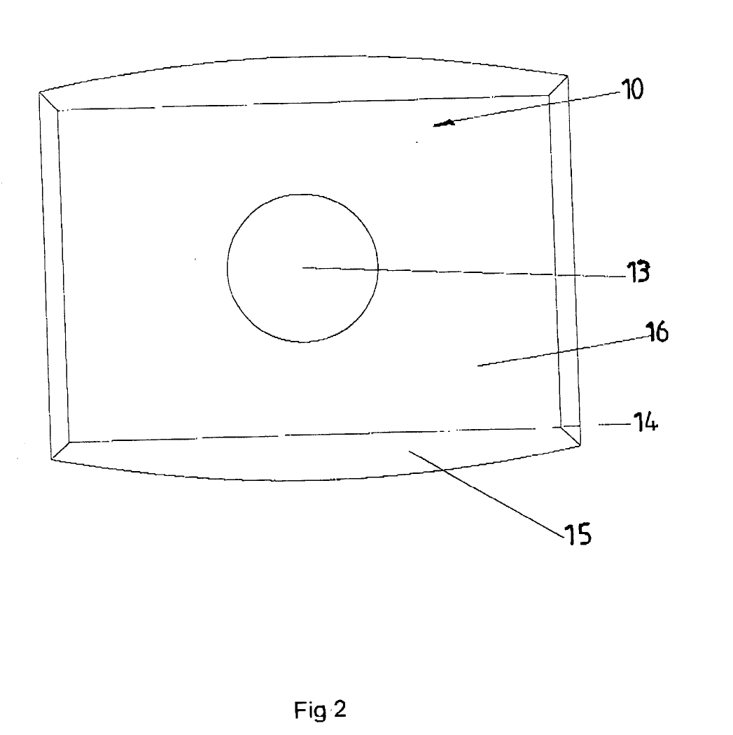

### DESCRIPTION OF A PREFERRED EMBODIMENT OF THE INVENTION

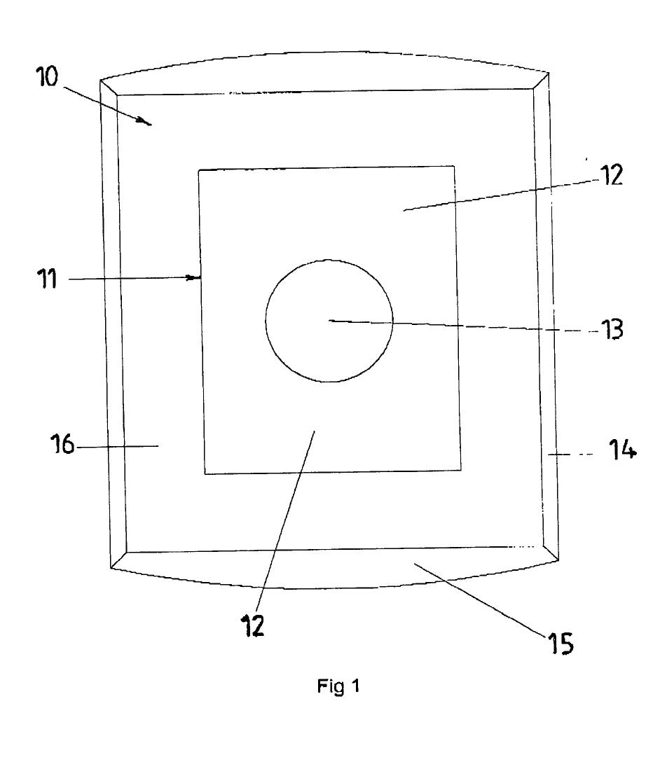

One preferred embodiment is depicted in FIG. 1. A substrate in the form of a glazed ceramic plaque 10 has placed upon it a digitally prepared and sealed decal 11. The decal 11 can include an image having an inscription portion 12 and a photographic image portion 13. The ceramic plaque 10 has bevelled edges 14 and a concave face 15. The decal 11, in this instance, does not cover the whole of the substrate allowing for the ceramic substrate to provide a margin 16.

The decal 11 is according to the preferred form of the invention prepared by creating a required image in digital form in a computer. This can include scanning or use of a digital camera to produce digital graphic(s) which can then be combined with text as required to form an image. The resultant digital image is then passed through an image processor (the processor can be a Raster Image Processor) to change text and graphics commands into descriptions of each mark on the image. The RIP enables a color copier to be used as a networked printer. Thus the processed image is then sent from the RIP to a color laser copier.

According to the preferred form of the invention the color laser copier is adapted to accommodate ceramic toner. A suitable toner is manufactured M and R Innovative Kommunication of Saarbrucken (Germany).

According to the preferred form of the invention the color laser copy is achieved by manually feeding sheets of a suitable decal paper into the ceramic toner adapted colour printer. A suitable decal paper is 130 Gsm Water Slidable Transfer Paper produced by Hoffmann and Engelmann of Neustadt, Germany.

Preferably the decal paper carrying the image is cover coated with a hot laminate. Alternatively, the cover coat can be screen printed on the decal paper. Prior to or following this step the decal sheet is trimmed just beyond the boundary of the image.

When using a laminate a suitable laminate is a product produced by D.K.S. s.r.l. of Castel Rozonne, Italy.

When screen printing on the cover coat the cover coat can comprise plasticised material in a mixture with screenprinting oil. A flux (ground glass) can be added. This mixture enables the cover coat to be applied, in association with a mesh size of the screen, at a thickness which can be varied depending on the desired outcome. The addition of a flux enables a cover coat to be achieved with a glass protective top layer.

The decal can then be submerged in tepid water for 1 or 2 minutes. This should free the backing paper so that the printed image with its over coat can be slid onto the glazed ceramic substrate. After positioning the decal air, water etc. can be squeezed away from the decal.

Preferably, the ceramic substrate and ceramic decal is cured by drying for up to 12 hours. The ceramic substrate and ceramic decal can then be fired in a kiln at a temperature of up to 850° C. for at least 30 minutes and then allowed to cool slowly before removal from the kiln. During this step the glaze on the substrate softens and the decal image fuses into the glaze. The remainder of the decal burns away leaving the ceramic colors and the over coat which remains as a permanent cover of the ceramic colors.

It is also to be understood that the process can also be used to make replicas of a less expensive form than that used for those plaques and the like intended for outdoor use. The image presented on the replicas would nevertheless be of the same superior quality as the outdoor version.

Generally the replicas would be ceramic in nature and of a size and weight suitable for placing on a mantle piece, desk top, and the like.

The invention is open to modification or different applications as will be appreciated by those skilled in the art such modifications and different applications being with the scope and spirit of the invention. For example the decal can be used to decorate a natural rock which will accept either a glazed or enamelled finish. In another application a headstone could be produced out of metal (e.g. steel slag waste) and then enamelled. The ceramic decal of the preset invention could then be used to decorate the headstone. While the firing procedures may well be different when decorating onto enamel the decal production as herein described is the same.

What is claimed is:

1. A process for preparing a ceramic decal the process including the steps of selecting a suitable ceramic substrate on to a surface of which is transferred a decal, the decal comprising a desired digital graphic image and wherein the decal is prepared in a one-step process without the need for either a film separation step or a screen-printing or similar printing step.

2. A process for producing a decal for a ceramic substrate the process including the steps of:—
(a) digitally preparing an image;
(b) converting the image prepared in step (a) to a format suitable for a color laser printer;
(c) converting a color laser printer to a ceramic decal printer;
(d) using the converted laser color printer to print the image prepared in step (c) as a decal; and
(e) cover coating the decal.

3. The process according to claim 1 wherein the decal is prepared by first passing the desired digital graphic image through an image processor to render the image in a format suitable for sending through a colored laser copier.

4. The process according to claim 2 wherein the image processor is a Raster Image Processor.

5. The process according to claim 2 wherein the color laser copier is adapted to accommodate ceramic toner.

6. The process according to claim 1 or 2 wherein the color laser copier is further converted into a ceramic detail color printer by manually feeding sheets of a suitable decal paper.

7. The process according to claim 2 wherein a suitable decal paper is used to print the decal in the color laser copier, the resultant decal paper carrying the image is further over coated with a hot laminate.

8. The process according to claim 6 wherein a cover coat is screen-printed on decal paper onto which the image has been printed by the color laser printer.

9. The process according to claim 8 wherein the cover coat comprises a mixture of plasticised material and screen-printing oil with optionally a flux.

10. The process according to claim 2 wherein the substrate is in the form of a ceramic plaque.

11. The process according to claim 9 wherein the plaque has bevel edges and a slightly convex surface.

12. The process as claimed in claim 9 wherein the area on the substrate selected to accommodate the image is glazed.

13. A ceramic substrate and decal combination produced by a process comprising a steps of:
(i) selecting a desired substrate of ceramic form,
(ii) digitally preparing an image conveying an inscription or decoration of a desired content and to a desired size,
(iii) converting the image prepared in step (ii) in a format suitable for a color laser printer,
(iv) converting a color laser printer into a ceramic decal printer,
(v) printing the image prepared in step (iv) as a decal and
(vi) cover coating the decal and applying the cover coated decal to the substrate by conventional techniques.

14. The process according to claim 13 wherein the image is prepared in a format suitable for a color laser printer via a Raster Image Processor.

15. The process according to claim 14 wherein the color laser printer is converted to a ceramic decal printer by a process which comprises replacing the color laser printer toner with ceramic toner.

16. The process according to claim 15 wherein the color laser printer is further adapted to accommodate decal paper.

17. The process according to claims 13 wherein the cover coating is carried out by the step of hot laminating.

18. The process according to claim 13 wherein the cover coat is screen-printed onto the decal.

19. The process according to claim 13 wherein the ceramic substrate comprising the ceramic decal is cured by drying for up to 12 hours.

20. The process according to claim 19 wherein the ceramic substrate comprising the ceramic decal is subsequently fired in a kiln at a temperature of up to about 850° C. for at least 30 minutes and then allowed cool slowly before removal.

21. A ceramic substrate and decal combination when formed by the process of claim 13.

22. A ceramic decal when formed by the process of claim 2.

23. The combination of claim 21 in the form of a plaque.
